(19) United States
(12) Patent Application Publication
(10) Pub. No.: US 2006/0140154 A1
(43) Pub. Date: Jun. 29, 2006

(54) Method and apparatus for signaling user equipment status information for uplink data transmission in a mobile communication system

(76) Inventors: Yong-Jun Kwak, Yongin-si (KR); Youn-Hyoung Heo, Suwon-si (KR); Kook-Heui Lee, Yongin-si (KR); Ju-Ho Lee, Suwon-si (KR); Joon-Young Cho, Suwon-si (KR); Youn-Bum Kim, Seoul (KR); Gert Jan Van Lieshout, Staines (GB)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/252,891

(22) Filed: Oct. 19, 2005

(30) Foreign Application Priority Data
Oct. 19, 2004 (KR) 83775/2004
Nov. 11, 2004 (KR) 92153/2004

(51) Int. Cl. H04B 7/216; H04L 12/56

(52) U.S. Cl. 370/335; 370/412; 370/342

(57) ABSTRACT

A method and apparatus for increasing the scheduling performance of a system supporting an uplink data service and total system stability by effectively UE status information to a Node B in a mobile communication system supporting the uplink data service are provided. UE status information including buffer occupancy information and transmit power status information is transmitted to a Node B periodically or upon generation of an event, irrespective of the presence or absence of uplink data to be transmitted. Since the buffer occupancy information and the transmit power status information are transmitted to the Node B by MAC-e signaling, physical channel resources are saved and E-DCH performance is improved.

### CROSS-REFERENCE TO RELATED APPLICATION

This application claims benefits under 35 U.S.C. § 119 from Korean Patent Applications Serial Nos. 2004-83775 and 2004-92153 filed in the Korean Intellectual Property Office on Oct. 19, 2004 and Nov. 11, 2004, respectively, the entire disclosures of which are hereby incorporated by reference.

### BACKGROUND OF THE INVENTION

1. Field of the Invention

The present invention relates generally to asynchronous Wideband Code Division Multiple Access (WCDMA) communications. In particular, the present invention relates to a method and apparatus for signaling the transmit power status (TPS), that is, uplink channel status of a User Equipment (UE) for use in uplink packet transmission scheduling.

2. Description of the Related Art

A 3^{rd} generation mobile communication system using WCDMA based on the European Global System for Mobile communications (GSM) system, Universal Mobile Telecommunication Service (UMTS) provides mobile subscribers or computer users with a uniform service of transmitting packet-based text, digitized voice, and video and multimedia data at or above 2 Mbps irrespective of their locations around the world. With the introduction of the concept of virtual access, the UMTS system allows access to any end point within a network at all times. The virtual access refers to packet-switched access using a packet protocol like Internet Protocol (IP).

FIG. 1 illustrates the configuration of the UMTS Terrestrial Radio Access Network (UTRAN) of a conventional UMTS system.

Referring to FIG. 1, a UTRAN 12 includes Radio Network Controllers (RNCs) 16a and 16b and Node Bs 18a to 18d and connects a UE 20 to a Core Network (CN) 10. A plurality of cells may underlie the Node Bs 18a to 18d. Each RNC 16a or 16b controls its underlying Node Bs and each Node B controls its underlying cells. An RNC, and Node Bs and cells under the control of the RNC collectively form a Radio Network Subsystem (RNS) 14a or 14b.

The RNCs 16a and 16b each allocate or manage radio resources to the Node Bs 18a to 18d under their control and the Node Bs 18a to 18d function to actually provide the radio resources. The radio resources are configured on a cell basis and the radio resources provided by the Node Bs 18a to 18d refer to radio resources of the cells that they manage. The UE establishes a radio channel using radio resources provided by a particular cell under a particular Node B, for communications. From the UE's point of view, a distinction between the Node Bs 18a to 18d and their controlled cells is meaningless and the UE 20 deals only with a physical layer configured on a cell basis. Therefore, the terms “Node B” and “cell” are interchangeably used herein.

A Uu interface is defined between a UE and an RNC. The hierarchical protocol architecture of the Uu interface is illustrated in detail in FIG. 2. This interface is divided into a control plane (C-plane) 30 for exchanging control signals between the UE and the RNC and a user plane (U-plane) 32 for transmitting actual data.

Referring to FIG. 2, a Radio Resource Control (RRC) layer 32, a Radio Link Control (RLC) layer 40, a Medium Access Control (MAC) layer 42, and a physical (PHY) layer 44 are defined on the C-plane 30. A Packet Data Control Protocol (PDCP) layer 36, a Broadcast/Multicast Control (BMC) layer 38, the RLC layer 40, the MAC layer 42, and the PHY layer 44 are defined on the U-plane 32. The PHY layer 44 resides in each cell and the MAC layer 42 through the RRC layer 34 are configured usually in each RNC.

The PHY layer 44 provides an information delivery service by a radio transfer technology, corresponding to Layer 1 (L1) in an Open System Interconnection (OSI) model. The PHY layer 44 is connected to the MAC layer 42 via transport channels. The mapping relationship between the transport channels and physical channels is determined according to how data is processed in the PHY layer 44.

The MAC layer 42 is connected to the RLC layer 40 via logical channels. The MAC layer 42 delivers data received from the RLC layer 40 on the logical channels to the PHY layer 44 on appropriate transport channels, and delivers data received from the PHY layer 44 on the transport channels to the RLC layer 40 on appropriate logical channels. The MAC layer 42 inserts additional information or interprets inserted data in data received on the logical channels and controls random access. A U-plane-related part is called MAC-data (MAC-d) and a C-plane-related part is called MAC-control (MAC-c) in the MAC layer 42.

The RLC layer 40 controls the establishment and release of the logical channels. The RLC layer 40 operates in one of an Acknowledged Mode (AM), an Unacknowledged Mode (UM) and a Transparent Mode (TM) and provides different functionalities in those modes. Typically, the RLC layer 40 segments or concatenates Service Data Units (SDUs) received form an upper layer to an appropriate size and correct errors.

The PDCP layer 36 resides above the RLC layer 40 in the U-plane 32. The PDCP layer 36 is responsible for compression and decompression of the header of data carried in the form of an IP packet and data delivery with integrity in the case where a serving RNC is changed-due to the UE's mobility.

The characteristics of the transport channels that connect the PHY layer 44 to the upper layers depend on Transport Format (TF) that defines PHY layer processes including convolutional channel encoding, interleaving, and service-specific rate matching.

Particularly, the UMTS system uses an Enhanced Uplink Dedicated CHannel (E-DCH) with the aim to further improve packet transmission performance on the uplink from UEs to a Node B. To support more stable high-speed data transmission, the E-DCH utilizes Hybrid Automatic Retransmission request (HARQ) and Node B-controlled scheduling.

FIG. 3 illustrates data transmission on the E-DCH via typical radio links. Reference numeral 100 denotes a Node B supporting the E-DCH 111 to 114 and reference numerals 101 to 104 denote UEs that transmit the E-DCH 111 to 114.

Referring to FIG. 3, the Node B 100 evaluates the channel statuses of the UEs 101 to 104 and schedules their uplink data transmissions based on the channel statues. The scheduling is performed such that a noise rise measurement does not exceed a target noise rise in the Node B 100 in order to increase total system performance. Therefore, the Node B 100 allocates a low data rate to a remote UE 104 and a high data rate to a nearby UE 101.

FIG. 4 is a diagram illustrating a typical signal flow for message transmission on the E-DCH.

Referring to FIG. 4, a Node B and a UE establish an E-DCH in step 202. Step 202 involves message transmission on dedicated transport channels. The UE transmits its UE status information to the Node B in step 204. The UE status information may contain information about the transmit power and power margin of the UE and the amount of buffered data to be transmitted to the Node B.

In step 206, the Node B monitors UE status information from a plurality of UEs to schedule uplink data transmissions for the individual UEs. The Node B decides to approve an uplink packet transmission from the UE and transmits scheduling assignment information to the UE in step 208. The scheduling assignment information includes an allowed data rate and an allowed timing.

In step 210, the UE determines the TF of the E-DCH based on the scheduling assignment information. The UE then transmits to the Node B TF information, that is, a Transport Format Resource Indicator (TFRI) and uplink packet data on the E-DCH at the same time in steps 212 and 214. The Node B determines whether the TFRI and the uplink packet data have errors in step 216. In the presence of errors in either of the TFRI and the uplink packet data, the Node B transmits an ACKnowledgement (ACK) signal to the UE, whereas in the absence of errors in both, the Node B transmits Non-ACKnowledgement (NACK) signal to the UE in step 218.

In the former case, the packet data transmission is completed and the UE transmits new packet data to the Node B on the E-DCH. On the other hand, in the latter case, the UE retransmits the same packet data to the Node B on the E-DCH.

As described above, the UE needs to transmit its UE status information to the Node B, to assist E-DCH scheduling. Particularly, the uplink transmit power information included in the UE status information is a significant factor in scheduling. Accordingly, a need exists for specifying how the uplink transmit power information is to be transmitted for efficient E-DCH transmission.

### SUMMARY OF THE INVENTION

An object of the present invention is to address at least the above problems and/or disadvantages. Accordingly, an object of the present invention is to provide a method and apparatus for transmitting information about the uplink transmit power of a UE to a Node B for use in uplink data transmission scheduling in the Node B.

Another object of the present invention is to provide a method and apparatus for transmitting information about the uplink transmit power of a UE to a Node B by transport channel data of an E-DCH.

The above exemplary objects of the present invention are achieved by providing an apparatus and method of transmitting UE status information for uplink data transmission in a mobile communication system.

According to one exemplary aspect of the present invention, in a method of transmitting UE status information for uplink data transmission in a mobile communication system, buffer occupancy (BO) information is generated by monitoring the amount of uplink data to be transmitted and transit power status (TPS) information is generated by monitoring uplink transmit power status. It is determined whether the BO information is to be transmitted in a current time interval. If the BO information is to be transmitted in the current time interval, it is determined whether the TPS information is to be transmitted in the current time interval according to a TPS period. If the TPS information is to be transmitted in the current time interval, a PDU including the BO information and the TPS information is generated and transmitted after coding and modulation.

According to another exemplary aspect of the present invention, in an apparatus for transmitting UE status information for uplink data transmission in a mobile communication system, a buffer buffers uplink data and generates BO information by monitoring the amount of the uplink data. A TPS information manager generates TPS information by monitoring uplink transmit power status. A UE status information generator determines whether the BO information is to be transmitted in a current time interval, determines whether the TPS information is to be transmitted in the current time interval, if the BO information is to be transmitted in the current time interval according to a TPS period, and generates UE status information including the BO information and the TPS information if the TPS information is to be transmitted in the current time interval. A PDU generator generates a PDU including the UE status information and a transmitter transmits the PDU after coding and modulation.

According to a further exemplary aspect of the present invention, in a method of transmitting UE status information for uplink data transmission in a mobile communication system, BO information is generated by monitoring the amount of uplink data to be transmitted, and TPS information is generated by monitoring uplink transmit power status. It is determined whether the BO information is to be transmitted in a current time interval. If the BO information is to be transmitted in the current time interval, it is determined whether a TPS information transmission event has occurred. If the TPS information transmission event has occurred, a PDU including the BO information and the TPS information is generated and transmitted after coding and modulation.

According to still another exemplary aspect of the present invention, in an apparatus for transmitting UE status information for uplink data transmission in a mobile communication system, a buffer buffers uplink data to be transmitted and generates BO information by monitoring the amount of the uplink data. A TPS information manager generates TPS information by monitoring uplink transmit power status. A UE status information generator determines whether the BO information is to be transmitted in a current time interval, determines whether a TPS information transmission event has occurred, if the BO information is to be transmitted in the current time interval, and generates UE status information including the BO information and the TPS information if the TPS information transmission event has occurred. A PDU generator generates a PDU including the UE status information, and a transmitter transmits the PDU after coding and modulation.

According to yet another exemplary aspect of the present invention, in a method of transmitting UE status information for uplink data transmission in a mobile communication system, BO information is generated by monitoring the amount of uplink data to be transmitted and TPS information is generated by monitoring uplink transmit power status. It is determined whether a current time interval is a BO transmission interval in which the BO information is to be transmitted. If the current time interval is the BO transmission interval, a PDU including the BO information and the TPS information is generated and transmitted after coding and modulation.

According to yet further exemplary aspect of the present invention, in an apparatus for transmitting UE status information for uplink data transmission in a mobile communication system, a buffer buffers uplink data to be transmitted and generates BO information by monitoring the amount of the uplink data. A TPS information manager generates TPS information by monitoring uplink transmit power status. A UE status information generator determines whether a current time interval is a BO transmission interval in which the BO information is to be transmitted, and generates UE status information including the BO information and the TPS information, if the current time interval is the BO transmission interval. A PDU generator generates a PDU including the UE status information, and a transmitter transmits the PDU after coding and modulation.

### BRIEF DESCRIPTION OF THE DRAWINGS

The above and other objects, features and advantages of the present invention will become more apparent from the following detailed description when taken in conjunction with the accompanying drawings in which like reference symbols indicate the same or similar components, wherein:

FIG. 1 illustrates the configuration of a UTRAN in a typical UMTS system;

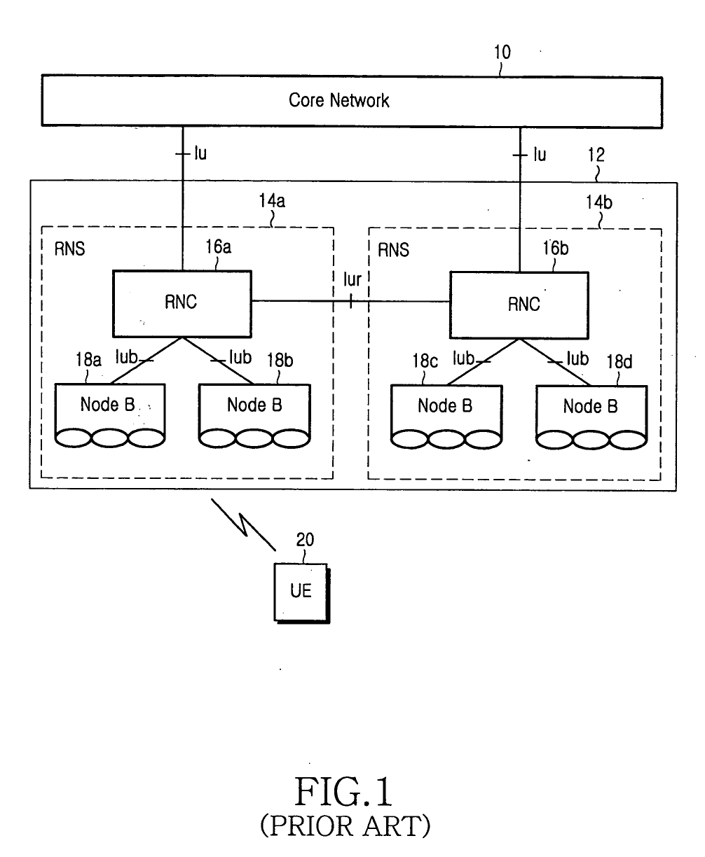

FIG. 2 illustrates the hierarchical architecture of an interface defined between a UE and an RNC;

FIG. 3 illustrates a conventional E-DCH transmission via a radio link;

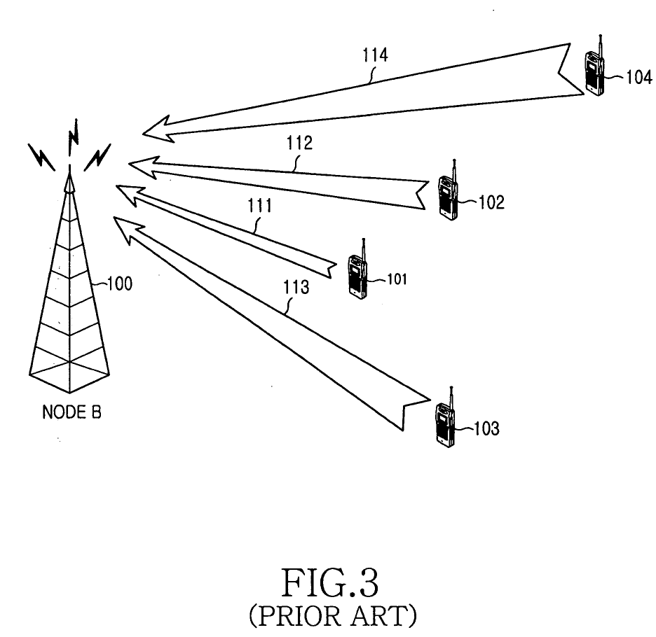

FIG. 4 is a diagram illustrating a conventional signal flow for message transmission/reception on an E-DCH;

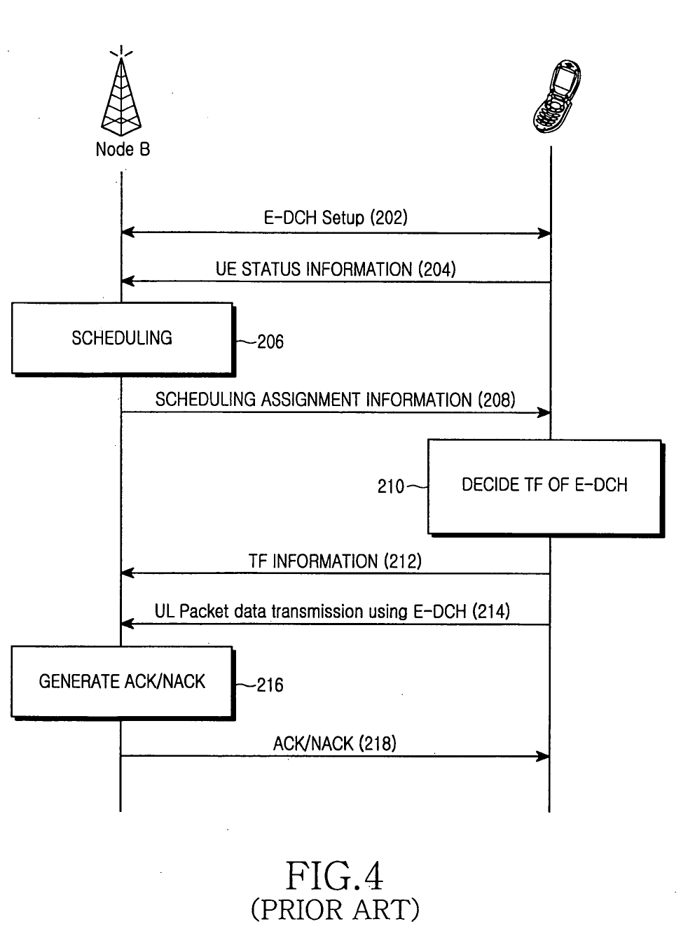

FIG. 5 illustrates the structure of a MAC-e Packet Data Unit (PDU);

FIG. 6 illustrates the configuration of MAC and PHY layers in relation to E-DCH transmission in a UE;

FIG. 7 illustrates the configuration of MAC and PHY layers in relation to E-DCH reception in a Node B;

FIG. 8 illustrates TPS transmission according to an exemplary embodiment of the present invention;

FIG. 9 illustrates TPS transmission according to another exemplary embodiment of the present invention;

FIG. 10 illustrates TPS transmission according to a third exemplary embodiment of the present invention;

FIG. 11 illustrates TPS transmission according to a fourth exemplary embodiment of the present invention;

FIG. 12 illustrates TPS transmission according to a fifth exemplary embodiment of the present invention;

FIG. 13 is a flowchart illustrating TPS transmission from a UE according to the fourth exemplary embodiment of the present invention;

FIG. 14 is a flowchart illustrating TPS transmission from a UE according to the fifth exemplary embodiment of the present invention; and

FIG. 15 is a block diagram of a UE for TPS transmission according to an exemplary embodiment of the present invention.

### DETAILED DESCRIPTION OF EXEMPLARY EMBODIMENTS

Exemplary embodiments of the present invention will be described herein below with reference to the accompanying drawings. In the following description, well-known functions or constructions are not described in detail for conciseness.

An exemplary object of the present invention is to transmit the TPS of a UE to a Node B. The TPS is expressed as the maximum transmit power of the UE or the transmit power of a control channel alone from the UE. Alternatively, TPS is expressed as a maximum data rate available to the UE or a TF. Alternatively, the uplink transmit power information can be the ratio of the maximum transmit power to the transmit power of the control channel, that is, the power margin of the UE. In this context, the TPS represents the uplink channel status of the UE.

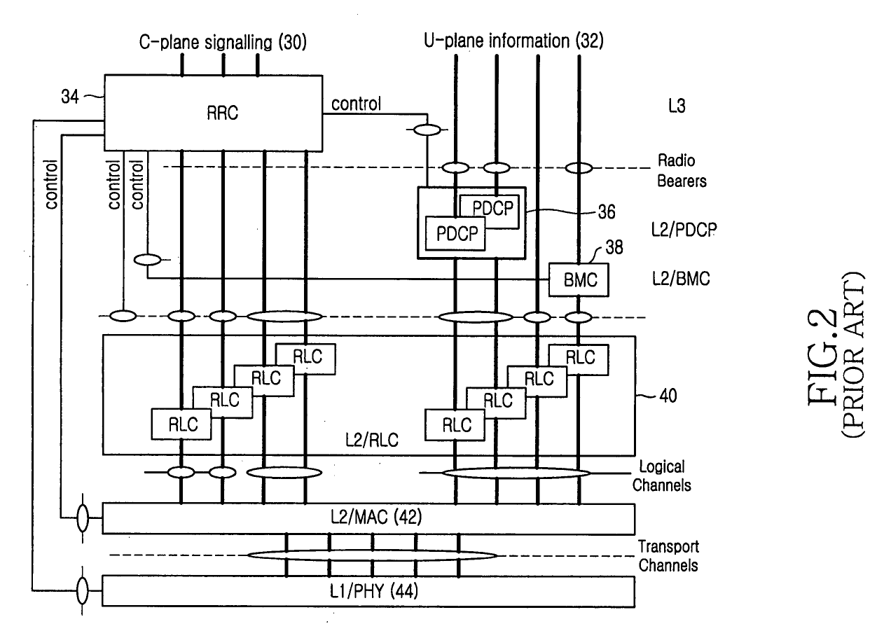

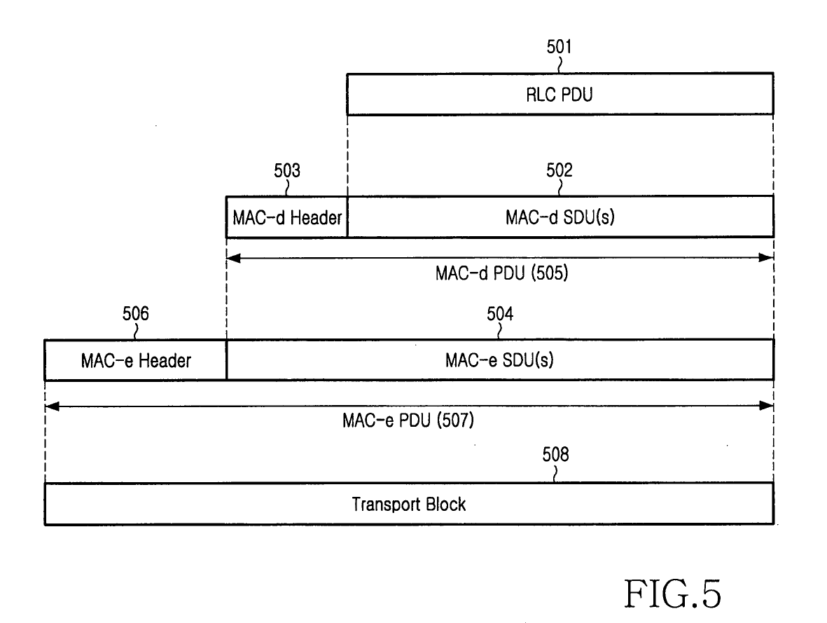

The TPS is transmitted to the Node B by MAC information in the exemplary embodiments of the present invention. As implied from its appellation, the MAC layer is responsible for medium access control between the RLC layer and the PHY layer. With the introduction of the E-DCH, the MAC layer configuration illustrated in FIG. 2 has been modified so that for the E-DCH functionality, a MAC-e entity is newly defined to work in conjunction with the existing MAC-d entity configured for a Dedicated CHannel (DCH). The MAC-e entity exists between the MAC-d entity and the PHY layer. As data is processed in the MAC layer, its format is changed as illustrated in FIG. 5.

Referring to FIG. 5, an RLC PDU 501 is data delivered from the RLC layer to the MAC layer. The MAC layer creates a MAC PDU by adding a MAC header to the RLC PDU 501 and provides the MAC PDU to the PHY layer. In the case of using the E-DCH, the MAC layer is divided into a MAC-d entity and a MAC-e entity and the MAC header attachment is carried out in the following two stages.

First, the MAC-d entity creates a MAC-d SDU 502 with one or more RLC PDUs 501 received from the RLC layer and adds a MAC-d header 503 to the MAC-d SDU 502, thus creating a MAC-d PDU 505. The MAC-d header 503 includes multiplexing information indicating a source (that is, RLC entity) from which the one or more RLC PDUs 501 were generated.

The MAC-d PDU 505 is delivered to the MAC-e entity. The MAC-e entity forms a MAC-e SDU 504 with one or more MAC-d PDUs 505 and adds a MAC-e header 506 to the MAC-e SDU 504, thus creating a MAC-e PDU 507. The MAC-e header 506 contains information about the one or more MAC-e SDUs 504 included in the MAC-e PDU 507. While the MAC-e header 506 is placed before the MAC-e SDU 504 in FIG. 5, it is to be understood that the MAC-e header 506 actually covers all information added by the MAC-e entity, other than the MAC-d PDU. The MAC-e PDU 507 is carried in the form of a transport block to the PHY layer and subject to transport channel processing including Cyclic Redundancy Check (CRC) attachment, channel coding, and rate matching, prior to transmission to a receiver.

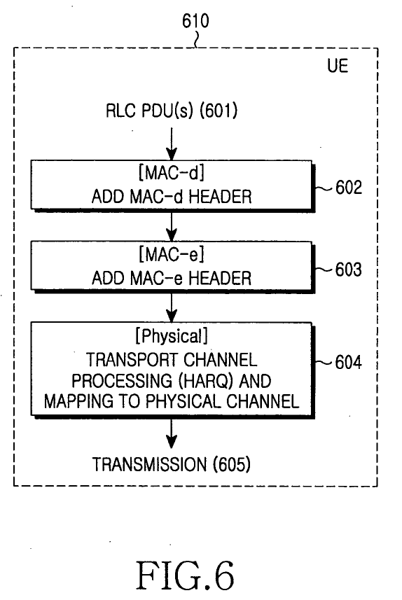

With reference to FIG. 6, a UE operation for generating data in the procedure illustrated in FIG. 5 will be described below.

Referring to FIG. 6, upon receipt of an RLC PDU 601, a MAC-d entity 602 generates a MAC-d PDU by adding a MAC-d header to the RLC PDU 601. A MAC-e entity 603 creates a MAC-e PDU by adding a MAC-e header to the MAC-d PDU. The MAC-e PDU is delivered to a PHY layer 604, is subject to transport channel processing including an HARQ operation, and is mapped to a PHY channel. The PHY channel is then transmitted as indicated by reference numeral 605. All this procedure illustrated in FIG. 6 is carried out in one UE 610.

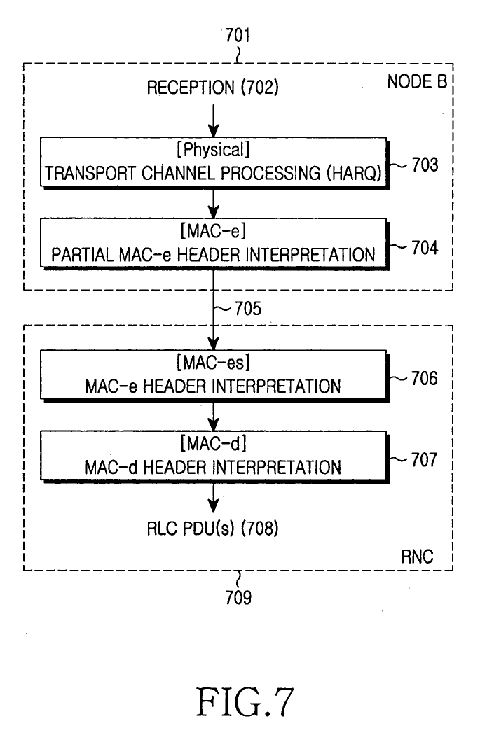

Now a description will be made of exemplary E-DCH data reception with reference to FIG. 7. Referring to FIG. 7, a Node B 701 includes a PHY layer 703 and a MAC-e entity 704. An RNC 709 includes a MAC-es entity 706, a MAC-d entity 707, and upper layers (not shown). The MAC-es entity 706 performs E-DCH-related signaling.

The Node B 701 receives a PHY channel to which the E-DCH is mapped, an Enhanced Dedicated Physical CHannel (E-DPCH) 702, and performs transport channel processing including an HARQ operation on the received signal in the PHY layer 703. The resulting transport block is provided to the MAC-e entity 704. The MAC-e entity 704 extracts a MAC-e header, including necessary information for the Node B 701, from the transport block and interprets the MAC-e header. The output of the MAC-e entity 704 is provided to the MAC-es entity 706 of the RNC 709 via an Iub interface 705.

As illustrated in FIG. 7, the MAC-e exists separately in the Node B 701 and the RNC 709 because the information of the MAC-e header can be divided into information needed for the Node B 701 and information needed for the RNC 709. Therefore, the data fed to the MAC-es entity 706 via the Iub interface 705 is a MAC-e PDU with the entire MAC-e header or a MAC-e PDU with only the information needed for the RNC 709 except for the information needed for the Node B 701.

The MAC-es entity 706 extracts the MAC-e header from the received MAC-e PDU and outputs the resulting MAC-d PDU. The MAC-d entity 707 extracts a MAC-d header from the MAC-d PDU, interprets the MAC-d header, and outputs the resulting RLC PDU 708. The RLC PDU 708 is appropriately processed in the upper layers (not shown) including the RLC layer.

The information needed for the Node B 701 set in the MAC-e header contains UE status information. The UE status information has buffer information indicating the amount of uplink data to be transmitted (hereinafter, referred to as BO short for Buffer Occupancy), and uplink channel status information (hereinafter, referred to as TPS short for Transmit Power Status). Transmission of the BO is periodic or event-triggered. Events that trigger the BO transmission include input of new data in an E-DCH buffer and the amount of buffered data exceeding a threshold. It is assumed herein that a BO transmission method is predetermined.

The UE uses a MAC-e PDU to transmit the TPS. Specifically, the UE transmits the TPS in the MAC-e header 506 on the E-DCH.

Besides the BO, the TPS is required for Node B-controlled scheduling, as stated before. The Node B interprets a TPS set in the MAC-e header of a received MAC-e PDU and transmits a MAC-e PDU with the TPS or a MAC-e PDU free of the TPS (i.e. a MAC-es PDU) to the MAC-es entity of the RNC. Transmission of control information like the BO or the TPS by a MAC-e header is called MAC-e signaling in the present invention.

Alternatively, the UE can transmit a TPS by a MAC-e control PDU, specifically in the MAC-e SDU 504 illustrated in FIG. 5. The process of inserting the TPS in the payload 504 instead of the MAC-e header 506 and transmitting the TPS is called MAC-e control PDU signaling in the present invention. The UE notifies the Node B of whether the MAC-e control PDU signaling is used by an Enhanced TF Index (E-TFI). Upon receipt of a MAC-e control PDU by the MAC-e control PDU signaling, the Node B may not transmit the MAC-e control PDU to the RNC.

Hereinbelow a description will be made of a method of transmitting a TPS to a Node B by MAC-e signaling in exemplary embodiments of the present invention. Since MAC-e control PDU signaling can be contemplated from the MAC-e signaling, TPS transmission by the MAC-e control PDU signaling will not be described in detail.

### First Exemplary Embodiment

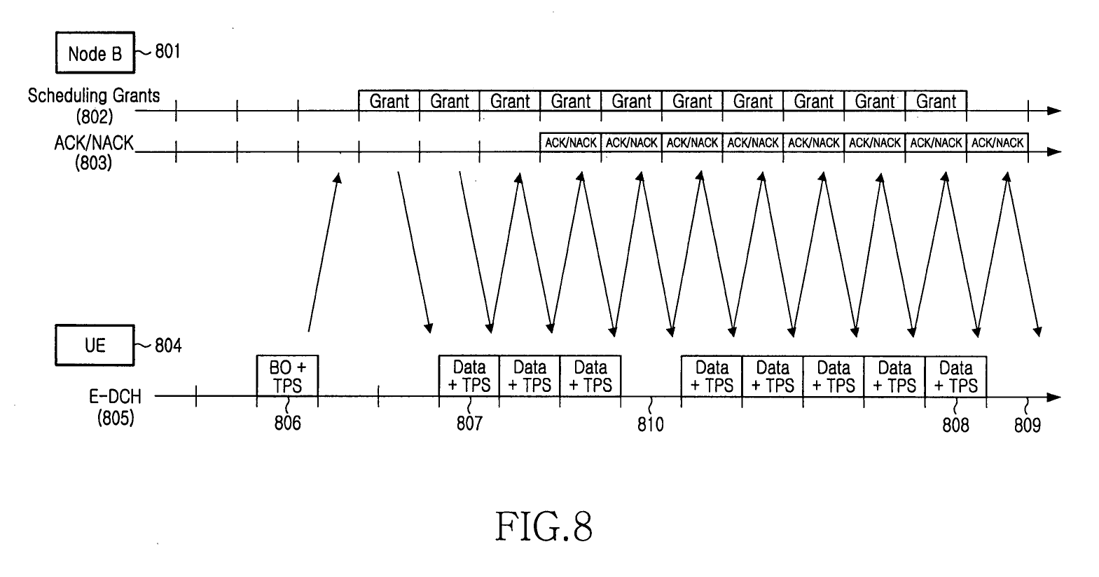

FIG. 8 illustrates TPS transmission using a MAC-e header from a UE for E-DCH scheduling according to an exemplary embodiment of the present invention.

Referring to FIG. 8, when new data is buffered, a UE 804 first transmits a BO & TPS 806 to a Node B 801 on an E-DCH 805. The BO & TPS 806 is included in an initial MAC-e PDU. The initial MAC-e PDU includes the BO or/and TPS in a MAC-e header with no data in payload and is transmitted by MAC-e signaling. The initial MAC-e PDU is used to indicate the start of data transmission on the E-DCH to the Node B 801.

Upon receipt of the BO or/and TPS on the E-DCH 805, the Node B 801 determines from the BO whether E-DCH data exists in the UE and schedules E-DCH data transmission based on the BO and TPS. The Node B 801 then transmits scheduling grant information to the UE 804 on a scheduling grant channel 802 as a result of the scheduling. The scheduling grant information can be the absolute value of available resources or the relative value of available resources to the previous resources. The former is called an absolute grant and the latter is called a relative grant. The Node B 801 receives a MAC-e PDU, performs an HARQ operation, and transmits an ACK/NACK signal to the UE 804 on an ACK/NACK channel 803.

The UE 804 transmits the E-DCH based on the scheduling grant information and the ACK/NACK signal. In accordance with the exemplary embodiment of the present invention, the UE transmits a TPS by a MAC-e header only in the presence of E-DCH data. In all E-DCH transmission time intervals 807 and 808, MAC-e PDUs have TPSs in their MAC-e headers.

On the other hand, in the absence of E-DCH data as before a time interval 807, no TPSs are transmitted. Yet, exceptionally a TPS can also be transmitted along with a BO in a BO transmission time interval. In a time interval 810 in which the buffer has data but the UE 804 is not allowed to transmit the data by scheduling or for any other reason, a TPS is not transmitted. When the buffer becomes empty, the UE 804 discontinues the TPS transmission as indicated by reference numeral 809.

Every time it receives a MAC-e PDU, the Node B 801 extracts a BO or/and TPS from the MAC-e PDU and performs scheduling based on the BO or/and TPS.

### Second Exemplary Embodiment

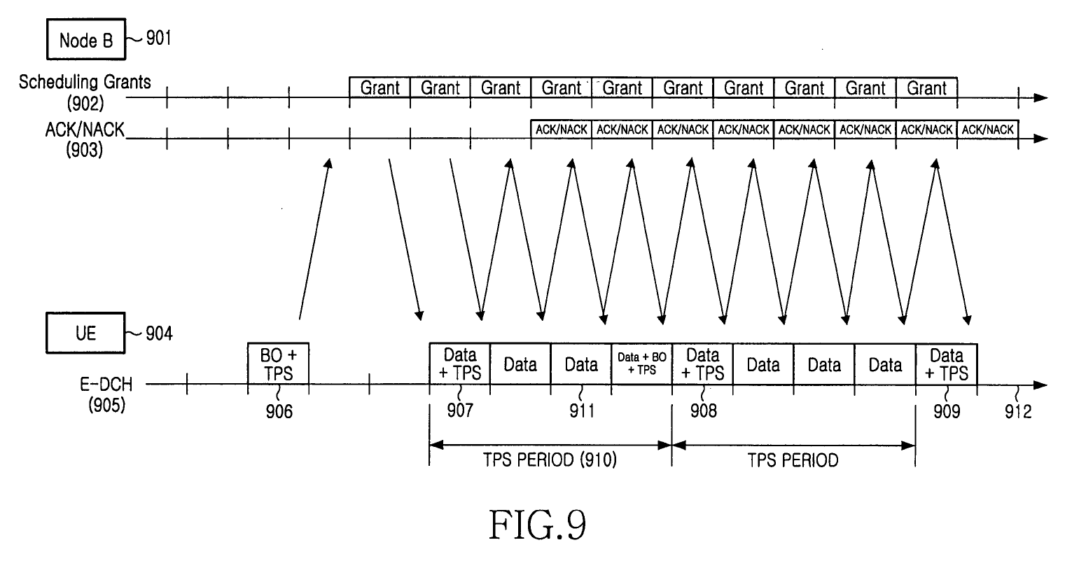

FIG. 9 illustrates periodic TPS transmission from a UE for E-DCH scheduling according to another exemplary embodiment of the present invention.

The UE transmits a TPS every predetermined TPS period. In the presence of E-DCH data in time intervals defined by the TPS period, a TPS is transmitted along with the E-DCH data in a MAC-e PDU. In the absence of E-DCH data, the MAC-e PDU contains only the TPS.

Referring to FIG. 9, when new data is buffered, a UE 904 first transmits a BO & TPS 906 in an initial MAC-e PDU to a Node B 901 on an E-DCH 905. The initial MAC-e PDU includes only the BO or/and TPS in a MAC-e header with no data in payload and is transmitted by MAC-e signaling.

Upon receipt of the BO or/and TPS, the Node B 901 determines from the BO whether the UE 904 has E-DCH data and schedules based on the BO and the TPS. The Node B 901 then transmits scheduling grant information to the UE 904 on a scheduling grant channel 902 as a result of the scheduling. The scheduling grant information can be an absolute grant or a relative grant. The Node B 901 receives the MAC-e PDU, performs an HARQ operation, and transmits an ACK/NACK signal to the UE 904 on an ACK/NACK channel 903.

The UE 904 transmits the E-DCH data based on the scheduling grant information and the ACK/NACK signal. In accordance with the second exemplary embodiment of the present invention, the UE 904 transmits a TPS every predetermined TPS period 910. For example, in the presence of E-DCH data, the UE 904 transmits a TPS in the MAC-e header of a MAC-e PDU with the E-DCH data. In the absence of E-DCH data, the UE 904 transmits a MAC-e PDU containing the TPS only. Thus, MAC-e PDUs with TPSs are transmitted in time intervals 907, 908 and 909 each apart from the following time interval by the TPS period 910.

The time intervals 907, 908 and 909 are limited to the case where an ACK signal is received for the previous MAC-e PDU or the number of transmissions of the previous MAC-e PDU has reached a maximum allowed number in an HARQ process. In other words, a TPS can be transmitted only in a time interval in which an initial transmission is possible. All conditions considered, the UE 904 transmits a TPS in the MAC-e header of an initial transmission MAC-e PDU in the earliest time interval in which TPS transmission is possible after expiration of the TPS period 910, that is, when the TPS period 910 has expired and the initial transmission MAC-e PDU has been created. The TPS period 910 is a predetermined fixed value or notified to the UE and the Node B from the RNC by upper layer signaling using Radio Resource Control (RRC) and Node B Application Part (NBAP) protocols.

In a BO transmission time interval 911, a TPS can also be transmitted in a MAC-e header even though the BO transmission time interval 911 is not a time interval in which TPS transmission is allowed according to the TPS period 910.

Before a time interval 907, that is, before the E-DCH data transmission, no TPSs are transmitted irrespective of the TPS period 910, except for a first BO transmission period 906 indicating the start of the E-DCH data transmission. In the time interval 906, the TPS and the BO are transmitted together. When there is no need for transmitting E-DCH data any longer, that is, when the buffer is empty in the UE 904, the UE 904 discontinues the E-DCH data transmission as indicated by reference numeral 912.

After receiving an initial MAC-e PDU containing a BO and a TPS only, the Node B 901 extracts the TPS from the first MAC-e PDU including data. Then, the Node B 904 extracts a TPS from a MAC-e PDU received every TPS period 910.

### Third Exemplary Embodiment

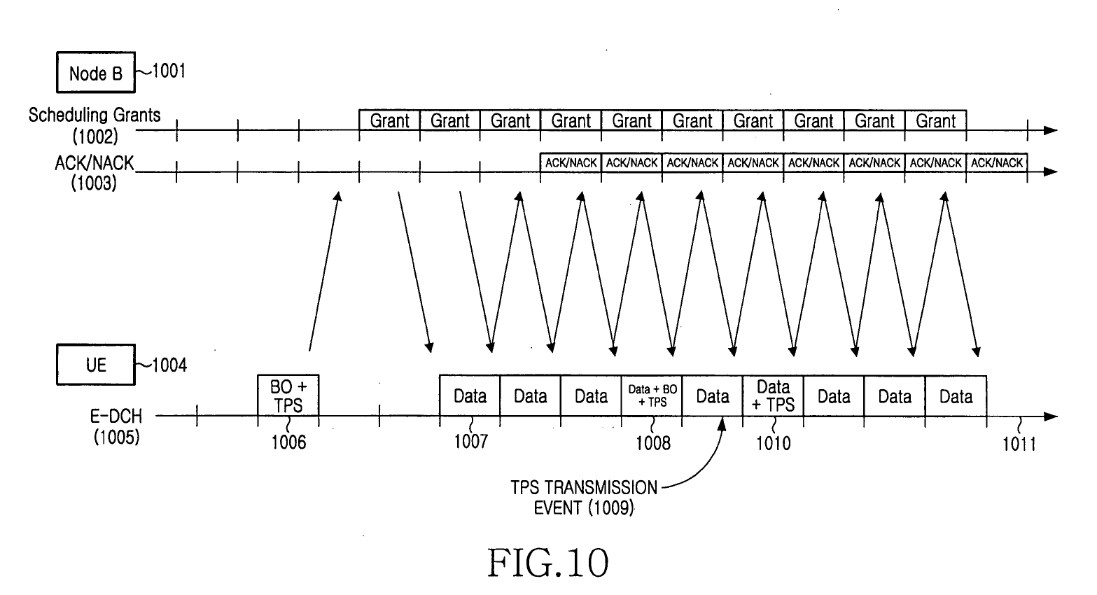

FIG. 10 illustrates event-triggered TPS transmission from a UE for E-DCH scheduling according to a third exemplary embodiment of the present invention.

The UE transmits a TPS when a predetermined event is fulfilled. When the event has occurred and E-DCH data exists, the UE transmits the E-DCH data and a TPS in a MAC-e PDU. In the absence of E-DCH data, the UE transmits a MAC-e PDU including only the TPS.

Referring to FIG. 10, when new data is buffered, a UE 1004 first transmits a BO & TPS 1006 in an initial MAC-e PDU to a Node B 1001 on an E-DCH 1005. The initial MAC-e PDU includes only the BO or/and TPS in a MAC-e header with no data in payload and is transmitted by MAC-e signaling.

Upon receipt of the BO or/and TPS, the Node B 1001 determines from the BO whether the UE 1004 has E-DCH data and schedules based on the BO and the TPS. The Node B 1001 then transmits scheduling grant information to the UE 1004 on a scheduling grant channel 1002 as a result of the scheduling. The scheduling grant information can be an absolute grant or a relative grant. The Node B 1001 receives the MAC-e PDU, performs an HARQ operation, and transmits an ACK/NACK signal to the UE 1004 on an ACK/NACK channel 1003.

The UE 1004 transmits the E-DCH data based on the scheduling grant information and the ACK/NACK signal. In accordance with the third exemplary embodiment of the present invention, the UE determines whether a predetermined event has occurred. Upon generation of the event, the UE 1004 transmits a TPS in a MAC-e PDU. To describe in more detail, in the presence of E-DCH data, the UE 1004 transmits a TPS in the MAC-e header of a MAC-e PDU with the E-DCH data. In the absence of E-DCH data, the UE 904 transmits a MAC-e PDU containing the TPS only.

For instance, when the difference between a TPS transmitted in the previous MAC-e PDU and the current TPS exceeds a predetermined threshold, this is an event that triggers TPS transmission. The UE 1004 transmits the TPS in a MAC-e header in a transmission time interval following the event. The threshold is a predetermined fixed value or notified to the UE and the Node B from the RNC by RRC and NBAP upper signaling. Many other events that trigger TPS transmission can be defined.

When the UE 1004 detects occurrence of a predetermined event in a time interval 1009, it transmits a TPS in a MAC-e header in the following time interval 1010. The time interval 1010 can be limited to the case where an ACK signal is received for the previous MAC-e PDU or the number of transmissions of the previous MAC-e PDU has reached a maximum allowed number in an HARQ process. That is, the TPS can be transmitted only when an initial transmission is possible. All conditions considered, the UE 1004 transmits a TPS in the MAC-e header of an initial transmission MAC-e PDU in the earliest time interval in which TPS transmission is possible after the event, that is, when the event has occurred and then the initial transmission MAC-e PDU has been created.

In a BO transmission time interval 1008, a TPS can also be transmitted in a MAC-e header even though the event has not occurred in the previous time interval to the BO transmission time interval 1008.

Before a time interval 1007, that is, before the E-DCH data transmission, no TPSs are transmitted irrespective of event occurrence, except for a first BO transmission period 1006 indicating the start of the E-DCH data transmission. In the time interval 1006, the TPS and the BO are transmitted together. When there is no need for transmitting E-DCH data any longer, that is, when the buffer is empty in the UE 1004, the UE 1004 discontinues the E-DCH data transmission as indicated by reference numeral 1011.

Every time the Node B 1001 receives a MAC-e PDU, it determines whether the MAC-e PDU includes a TPS based on a MAC-e signaling indicator bit set in the MAC-e PDU. If the MAC-e signaling indicator bit indicates the presence of the TPS, the Node B 1001 extracts the TPS from the MAC-e PDU and uses the TPS in scheduling.

### Fourth Exemplary Embodiment

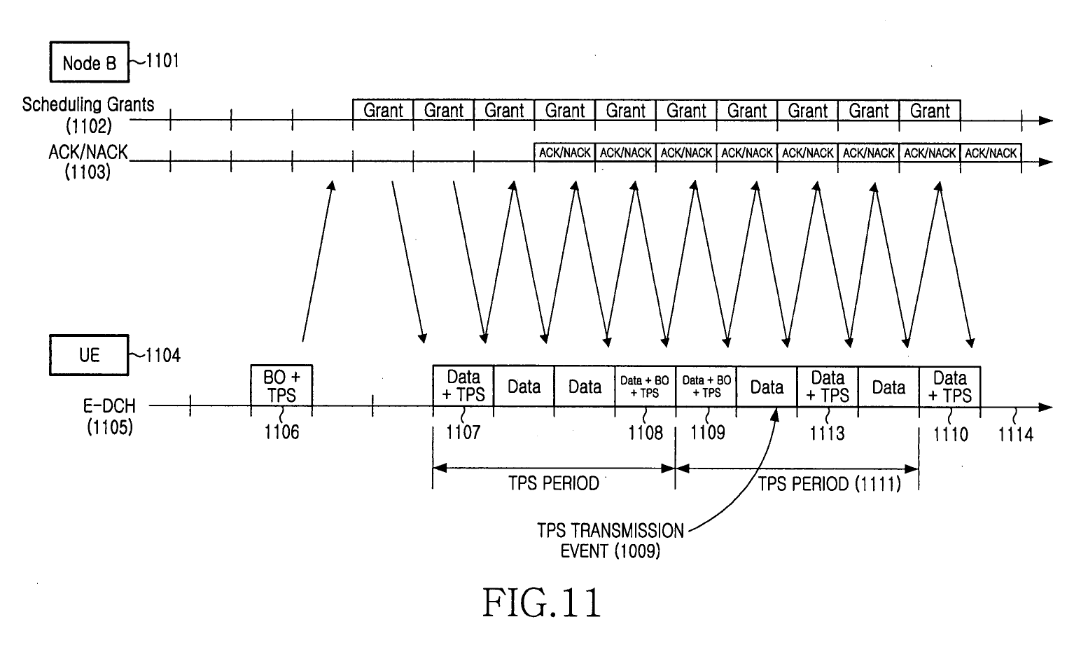

FIG. 11 illustrates periodic or event-triggered TPS transmission from a UE for E-DCH scheduling according to a fourth exemplary embodiment of the present invention.

The UE transmits a TPS not only when a predetermined event is fulfilled but also every predetermined TPS period. As the UE transmits a TPS in an event-triggered manner and in addition, periodically, the periodic TPS transmission ensures stable TPS transmission despite failure of the event-triggered TPS transmission. When either the event has occurred or the TPS period has expired, in the presence of E-DCH data, the TPS is transmitted along with the E-DCH data in a MAC-e PDU. In the absence of E-DCH data, the MAC-e PDU contains only the TPS.

Referring to FIG. 11, when new data is buffered, a UE 1104 first transmits a BO & TPS 1106 in an initial MAC-e PDU to a Node B 1101 on an E-DCH 1105. The initial MAC-e PDU includes only the BO or/and TPS in a MAC-e header with no data in payload and is transmitted by MAC-e signaling.

Upon receipt of the BO or/and TPS, the Node B 1101 determines from the BO whether the UE 1104 has E-DCH data and schedules based on the BO and the TPS. The Node B 1101 then transmits scheduling grant information to the UE 1104 on a scheduling grant channel 1102 as a result of the scheduling. The scheduling grant information can be an absolute grant or a relative grant. The Node B 1101 receives the MAC-e PDU, performs an HARQ operation, and transmits an ACK/NACK signal to the UE 1104 on an ACK/NACK channel 1103.

The UE 1104 transmits the E-DCH data based on the scheduling grant information and the ACK/NACK signal. In accordance with the fourth exemplary embodiment of the present invention, the UE 1104 transmits a TPS every predetermined TPS period 1111. Besides the periodic TPS transmission, the UE 1104 additionally transmits a TPS when the event occurs. In the presence of E-DCH data, the UE 1104 transmits a TPS in the MAC-e header of a MAC-e PDU with the E-DCH data. In the absence of E-DCH data, the UE 1104 transmits a MAC-e PDU containing the TPS only.

For instance, when the difference between a TPS transmitted in the previous MAC-e PDU and the current TPS exceeds a predetermined threshold, this is an event that triggers TPS transmission. The UE 1104 transmits the TPS in a MAC-e header in a transmission time interval following the event. The threshold is a predetermined fixed value or notified to the UE and the Node B from the RNC by RRC and NBAP upper signaling. Many other events that trigger TPS transmission can be defined. The TPS period 1111 is also a predetermined fixed value or notified to the UE and the Node B by RRC and NBAP upper signaling.

In time intervals 1107, 1109 and 1110, the UE 1104 transmits TPSs according to the TPS period 1111. Also, when the UE 1104 detects occurrence of the event in a time interval 1112, it transmits a TPS in the following time interval 1113. The time intervals 1107, 1109, 1110 and 1113 carrying the TPSs are limited to the case where an ACK signal is received for the previous MAC-e PDU or the number of transmissions of the previous MAC-e PDU has reached a maximum allowed number in an HARQ process. In other words, a TPS can be transmitted only in a time interval in which an initial transmission is possible.

Therefore, all conditions considered, the UE 1104 transmits a TPS in the MAC-e header of an initial transmission MAC-e PDU in the earliest time interval in which TPS transmission is possible after expiration of the TPS period 1111 or occurrence of the event, that is, when the TPS period 1111 has expired or the event has occurred, and the initial transmission MAC-e PDU has been created.

In a BO transmission time interval 1108, a TPS can also be transmitted in a MAC-e header even though the BO transmission time interval 1108 is neither a time interval in which TPS transmission is allowed according to the TPS period 1111 nor a time interval following occurrence of the event.

Before a time interval 1107, that is, before the E-DCH data transmission, no TPSs are transmitted irrespective of the TPS period 1111 and the event, except for a first BO transmission period 1106 indicating the start of the E-DCH data transmission. In the time interval 1106, the TPS and the BO are transmitted together. When there is no need for transmitting E-DCH data any longer, that is, when the buffer is empty in the UE 1104, the UE 1104 discontinues the E-DCH data transmission as indicated by reference numeral 1114.

After receiving an initial MAC-e PDU containing a BO and a TPS only, the Node B 1101 extracts the TPS from the first MAC-e PDU including data. Then, the Node B 1104 extracts a TPS from a MAC-e PDU received every TPS period 1111. Also, every time the Node B 1101 receives a MAC-e PDU, it determines whether the MAC-e PDU includes a TPS based on a MAC-e signaling indicator bit set in the MAC-e PDU. In the presence of the TPS, the Node B 1101 extracts the TPS from the MAC-e PDU and uses the TPS in scheduling.

### Fifth Exemplary Embodiment

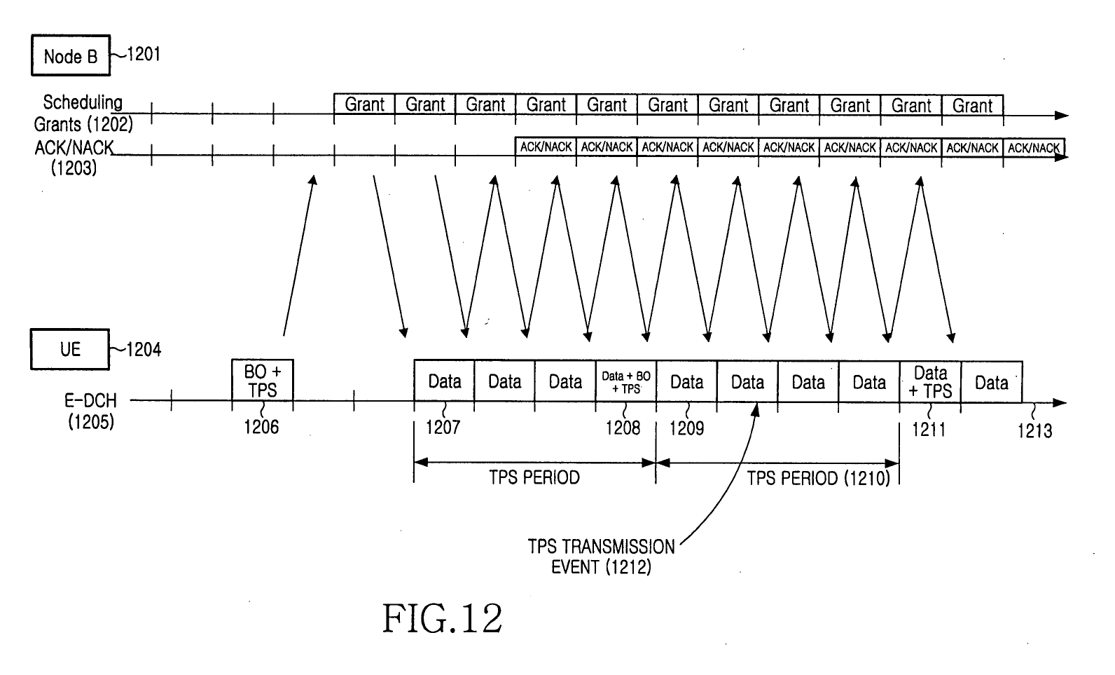

FIG. 12 illustrates periodic event-triggered TPS transmission from a UE for E-DCH scheduling according to a fifth exemplary embodiment of the present invention.

The UE monitors a predetermined TPS period. Only when a predetermined event is fulfilled upon expiration of the TPS period, the UE transmits a TPS. When the TPS period has expired and the event has occurred, in the presence of E-DCH data, the TPS is transmitted along with the E-DCH data in a MAC-e PDU. In the absence of E-DCH data, the MAC-e PDU contains only the TPS.

Referring to FIG. 12, when new data is buffered, a UE 1204 first transmits a BO & TPS 1206 in an initial MAC-e PDU to a Node B 1201 on an E-DCH 1205. The initial MAC-e PDU includes only the BO or/and TPS in a MAC-e header with no data in payload and is transmitted by MAC-e signaling.

Upon receipt of the BO or/and TPS, the Node B 1201 determines from the BO whether the UE 1104 has E-DCH data and schedules based on the BO and the TPS. The Node B 1201 then transmits scheduling grant information to the UE 1204 on a scheduling grant channel 1202 as a result of the scheduling. The scheduling grant information can be an absolute grant or a relative grant. The Node B 1201 receives the MAC-e PDU, performs an HARQ operation, and transmits an ACK/NACK signal to the UE 1204 on an ACK/NACK channel 1203.

The UE 1204 transmits the E-DCH data based on the scheduling grant information and the ACK/NACK signal. In accordance with the fifth exemplary embodiment of the present invention, the UE 1204 determines whether the event has occurred in time intervals 1207, 1209 and 1211 defined by the TPS period 1210 and transmits a TPS in the time interval 1211 for which the event is fulfilled. In the presence of E-DCH data, the UE 1204 transmits a TPS in the MAC-e header of a MAC-e PDU with the E-DCH data. In the absence of E-DCH data, the UE 1204 transmits a MAC-e PDU containing the TPS only.

For instance, when the difference between the previous TPS and the current TPS exceeds a predetermined threshold, this is an event that triggers TPS transmission. The UE 1204 transmits the TPS in a MAC-e header in a transmission time interval following the event. The threshold is a predetermined fixed value or notified to the UE and the Node B from the RNC by RRC and NBAP upper signaling.

Many other events that trigger TPS transmission can be defined. The TPS period 1210 is also a predetermined fixed value or notified to the UE and the Node B by RRC and NBAP upper signaling.

In time intervals 1207, 1209 and 1211 each apart from the following time interval by the TPS period 1210, the UE 1204 determines whether the event has occurred in the previous time interval. Upon occurrence of the event in a time interval 1212, the UE 1204 transmits a TPS in the following time interval 1211. In the time intervals 1207 and 1209, no TPSs are transmitted because the TPS period 1210 has expired but the event has not occurred. The time interval 1211 carrying the TPS is limited to the case where an ACK signal is received for the previous MAC-e PDU or the number of transmissions of the previous MAC-e PDU has reached a maximum allowed number in an HARQ process. In other words, a TPS can be transmitted only in a time interval in which an initial transmission is possible.

Therefore, all conditions considered, the UE 1104 transmits a TPS in the MAC-e header of an initial transmission MAC-e PDU in the earliest time interval when the TPS period 1210 has expired after occurrence of the event.

In a BO transmission time interval 1208, a TPS can also be transmitted in a MAC-e header even though the TPS period 1210 has expired in the BO transmission time interval 1208 after the event occurred.

Before a time interval 1207, that is, before E-DCH data transmission, no TPSs are transmitted irrespective of the TPS period 1210 and the event, except a first BO transmission period 1206 indicating the start of the E-DCH data transmission. In the time interval 1206, the TPS and the BO are transmitted together. When there is no need for transmitting E-DCH data any longer, that is, when the buffer is empty in the UE 1204, the UE 1204 discontinues the E-DCH data transmission as indicated by reference numeral 1213.

Every time the Node B 1201 receives a MAC-e PDU, it determines whether the MAC-e PDU includes a TPS based on a MAC-e signaling indicator bit set in the MAC-e PDU. In the presence of the TPS, the Node B 1101 extracts the TPS from the MAC-e PDU and uses the TPS in scheduling.

### Sixth Exemplary Embodiment

In this exemplary embodiment of the present invention, the UE transmits a BO and a TPS together at both a BO transmission time and a TPS transmission time by MAC-e signaling.

In the case where BO transmission is confined to a BO transmission time and TPS transmission to a TPS transmission time, the MAC-e PDU has very different sizes. As a result, the amount of PHY layer signaling information to deliver information about a MAC-e PDU size on an E-DCH control channel, Enhanced-Dedicated Physical Control CHannel (E-DPCCH) can be increased. Therefore, the UE allocates a BO field of a predetermined size and a TPS field of a predetermined size and when it needs to transmit either the BO or the TPS, the UE fills both the BO and the TPS in the two fields all the time. Thus, the number of the MAC-e PDU sizes is reduced and as a result, the amount of the MAC-e PDU size information is decreased.

Separate BO and TPS transmission as in the previous exemplary embodiments of the present invention physically requires a 2-bit information field to represent four MAC-e signaling types for each MAC-e PDU: BO only, TPS only, both BO and TPS, and none. However, concurrent BO and TPS transmission physically needs only a 1-bit information field to represent two MAC-e signaling types: both BO and TPS and none. Therefore, the number of bits required to indicate MAC-e signaling is reduced.

TPS transmission is carried out by MAC-e signaling every predetermined TPS period, or in an event-triggered manner, or in both in the above-described exemplary embodiments. BO transmission is carried out by MAC-e signaling in the same manner. Therefore once the conditions for transmitting the BO and the TPS are set, separately, if either of the conditions is satisfied, both the BO and TPS are transmitted by MAC-e signaling.

A BO period may be equal to or different from a TPS period and BO and TPS transmission time intervals are set separately. For example, the BO is initially transmitted when data is first buffered in the E-DCH buffer of the UE. An event that triggers BO transmission can be defined as buffering of new data in the E-DCH buffer or buffered data filled to a threshold. An event that triggers TPS transmission can be defined as a great channel status change or a band channel status.

The sizes of the BO and TPS are predetermined and the BO and TPS size information and E-DCH data form a MAC-e PDU or MAC-e signaling. That is, a MAC-e PDU for MAC-e signaling is configured to include a BO field and a TPS field and these fields are filled with a BO and a TPS when MAC-e signaling is performed.

The UE determines every time interval whether the BO period or the TPS period has expired. If neither of the BO and TPS periods has expired, the UE determines whether a BO event or a TPS event has occurred. If either of the BO and TPS periods has expired or either of the BO and TPS events has occurred, the UE inserts a BO and a TPS in a MAC-e PDU and transmits the MAC-e PDU.

In accordance with the sixth exemplary embodiment of the present invention, the following operation can be further contemplated.

The UE sets a MAC-e signaling field to contain a BO and a TPS. If a BO transmission condition is satisfied, the BO is written in a BO field and null data is filled in a TPS field within the MAC-e signaling field. On the other hand, if a TPS transmission condition is satisfied, the TPS is written in the TPS field and null data is filled in the BO field within the MAC-e signaling field. In this case, two information bits are physically required to represent four MAC-e signaling types.

Every time it receives a MAC-e PDU, the Node B checks a MAC-e signaling indicator bit in the MAC-e PDU. If the MAC-e signaling indicator bit indicates the presence of UE status information, the Node B extracts a BO and a TPS from the MAC-e PDU and schedules based on the BO and the TPS.

Exemplary implementations of certain embodiments of the present invention and a related block diagram will be described below.

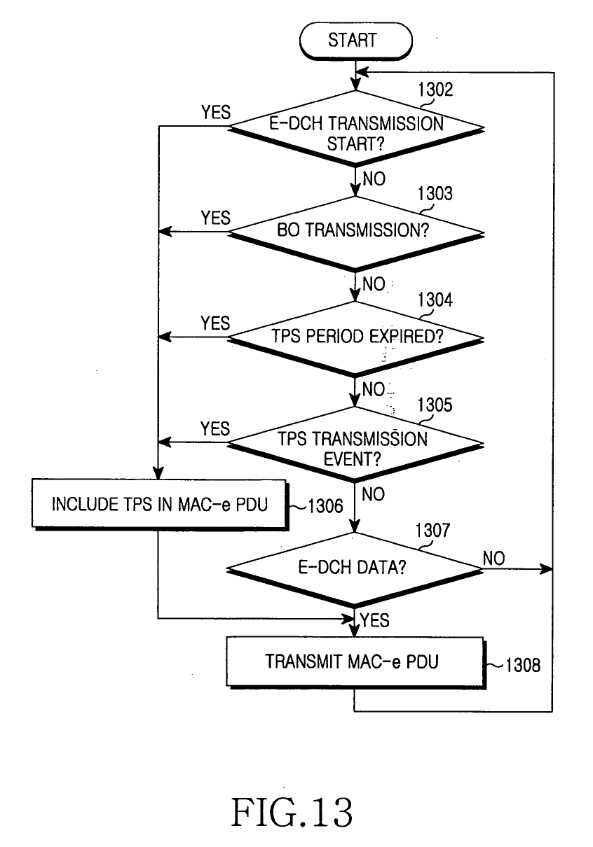

FIG. 13 is a flowchart illustrating TPS transmission from a UE according to the fourth exemplary embodiment of the present invention. Step 1302 through step 1308 are performed in every E-DCH transmission interval.

Referring to FIG. 13, the UE determines whether E-DCH data transmission is to start in step 1302. If the UE determines that the E-DCH data transmission will start in the current time interval, it includes a BO and a TPS in a MAC-e PDU in step 1306 and proceeds to step 1308. If the E-DCH data transmission will not start in the current time interval, the UE determines whether a BO is to be transmitted in the current time interval in step 1303. If the current time interval is a BO transmission interval, the UE includes the BO and the TPS in a MAC-e PDU in step 1306 and proceeds to step 1308. If the TPS is transmitted irrespective of the BO in another embodiment, step 1303 will not be performed.

If the current time interval is not a BO transmission interval, the UE determines whether a TPS period has expired in step 1304. That is, the UE determines whether the TPS period has elapsed after transmission of the previous TPS or the start of the E-DCH data transmission. If the current time interval is a TPS transmission interval, the UE includes the TPS in the MAC-e PDU in step 1306 and proceeds to step 1308. If the current time interval is not a TPS transmission interval, the UE determines whether a TPS event has occurred in the previous time interval in step 1305. If the TPS event has occurred in the previous time interval, the UE includes the TPS in the MAC-e PDU in step 1306 and proceeds to step 1308.

If the TPS event has not occurred in step 1305, the LJE determines whether E-DCH data exists for transmission in step 1307. In the presence of E-DCH data, the UE fills the E-DCH data in the payload of the MAC-e PDU and transmits the MAC-e PDU in step 1308. The MAC-e PDU may include the BO or/and TPS inserted in step 1306. In the absence of E-DCH data, the UE waits till the next time interval and returns to step 1302. It can be further contemplated as another exemplary embodiment that in the absence of E-DCH data to be transmitted, a MAC-e PDU including only a BO or/and TPS is transmitted.

When applying the flowchart of FIG. 13 to the first exemplary embodiment, the UE proceeds to step 1307 directly if the E-DCH data transmission is not to start in the current time interval in step 1302. In the second embodiment, the UE directly jumps to step 1307 if the TPS period has not expired in step 1304. In the third embodiment, the UE directly jumps to step 1305 if the E-DCH data transmission is not to start in the current time interval in step 1302 or if the current time interval is not a BO transmission interval in step 1303.

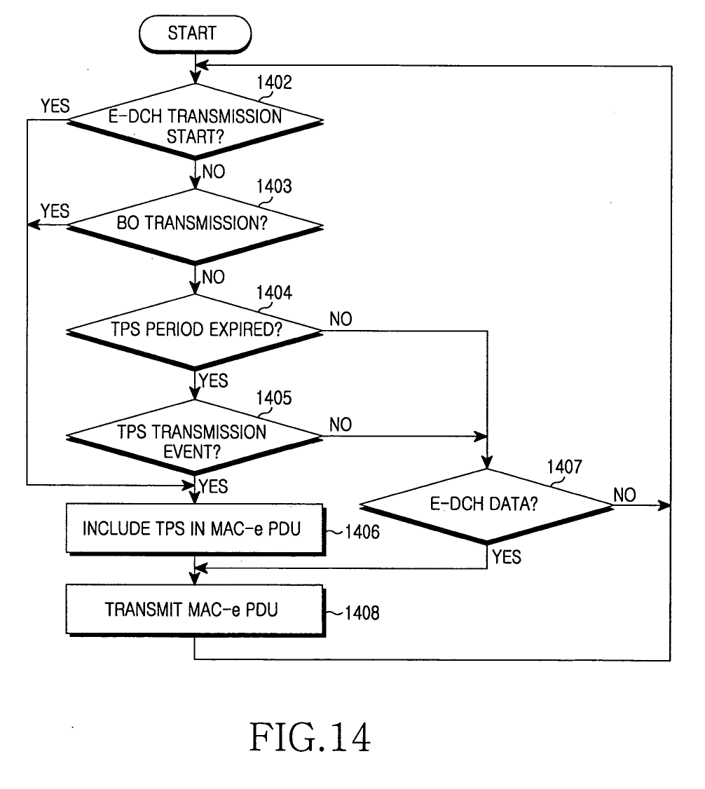

FIG. 14 is a flowchart illustrating TPS transmission from a UE according to the fifth exemplary embodiment of the present invention. Step 1402 through step 1408 are performed in every E-DCH transmission interval.

Referring to FIG. 14, the UE determines whether E-DCH data transmission is to start in step 1402. If the UE determines that the E-DCH data transmission will start in the current time interval, it includes a BO and a TPS in a MAC-e PDU in step 1406 and proceeds to step 1408. If the E-DCH data transmission will not start in the current time interval, the UE determines whether a BO is to be transmitted in the current time interval in step 1403. If the current time interval is a BO transmission interval, the UE includes the BO and the TPS in a MAC-e PDU in step 1406 and proceeds to step 1408. If the TPS is transmitted irrespective of the BO in another exemplary embodiment, step 1403 will not be performed.

If the current time interval is not a BO transmission interval, the UE determines whether a TPS period has expired in step 1404. That is, the UE determines whether the TPS period has elapsed after transmission of the previous TPS or the start of the E-DCH data transmission. If the current time interval is not a TPS transmission interval, the UE goes to step 1407. On the other hand, if the current time interval is a TPS transmission interval, the UE determines whether a TPS event has occurred for the previous TPS period in step 1405. If the TPS event has occurred in the previous TPS period, the UE includes the TPS in the MAC-e PDU in step 1406 and proceeds to step 1408. If the TPS event has not occurred in step 1405, the UE proceeds to step 1407.

In step 1407, the UE determines whether E-DCH data exists for transmission. In the presence of E-DCH data, the UE fills the E-DCH data in the payload of the MAC-e PDU and transmits the MAC-e PDU in step 1408. The MAC-e PDU may include the BO or/and TPS inserted in step 1406. In the absence of E-DCH data, the UE waits till the next time interval and returns to step 1402. It can be further contemplated as another embodiment that in the absence of E-DCH data to be transmitted, a MAC-e PDU including only a BO or/and TPS is transmitted.

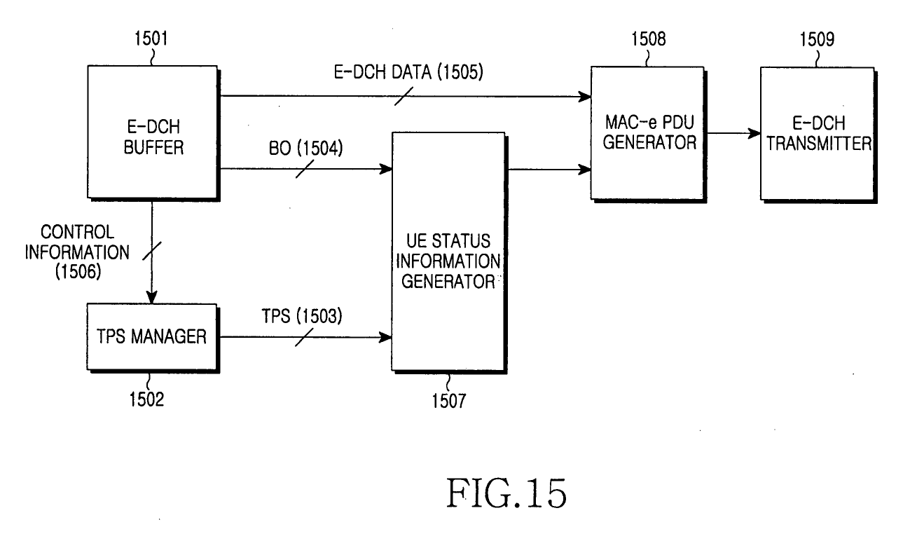

FIG. 15 is a block diagram of a UE according to an exemplary embodiment of the present invention. It is to be appreciated that components of the receiver not related to the subject matter of the present invention are not shown in FIG. 15.

Referring to FIG. 15, the UE includes an E-DCH buffer 1501 for buffering E-DCH data and a TPS manager 1502 for managing a TPS. The E-DCH buffer 1501 monitors the amount of uplink data, correspondingly generates a BO 1504, and provides the BO 1504 to a UE status information generator 1507. The TPS manager 1502 has knowledge of a maximum transmit power available to the UE, monitors the transmit power of each channel according to Node B power control and according to whether uplink channels are in use or not, correspondingly generates a TPS 1503, and provides the TPS 1503 to the UE status information generator 1507.

The UE status information generator 1507 determines whether it is time to transmit the BO 1504 or the TPS 1503 and generates UE status information with the BO 1504 or/and the TPS 1503. The criterion for including the BO 1504 in the UE status information can be periodic transmission, event-triggered transmission, or initial E-DCH transmission. Similarly, the criterion for including the TPS 1503 in the UE status information can be periodic transmission, event-triggered transmission, or initial E-DCH transmission, as in the embodiments of the present invention. The TPS manager 1502 may provides the TPS 1503 to the UE status information generator 1507 according to control information 1506 indicating whether the BO 1504 is to be transmitted, received from the E-DCH buffer 1501.

The E-DCH buffer 1501 outputs E-DCH data 1505 at an allowed data rate in each transmission interval. The E-DCH data 1505 is provided to a MAC-e. PDU generator 1508, and when MAC-e signaling is needed, the UE status information generator 1507 provides the UE status information including the BO 1504 and the TPS 1503 to the MAC-e PDU generator 1508. The MAC-e PDU generator 1508 generates a MAC-e PDU containing at least one of the E-DCH data and the UE status information. The MAC-e PDU is transmitted to a Node B, after coding and modulation in an E-DCH transmitter 1509.

As described above, the present invention can enable accurate, efficient TPS transmission to assist rate scheduling for uplink packet transmission in a WCDMA communication system supporting the E-DCH. A UE transmits a TPS in a MAC-e header by MAC-e signaling along with E-DCH data to a Node B. Therefore, PHY channel resources are saved and the efficient TPS transmission improves E-DCH performance.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of transmitting user equipment (UE) status information for uplink data transmission in a mobile communication system, the method comprising the steps of:
generating buffer occupancy (BO) information by monitoring an amount of uplink data to be transmitted;
generating transmit power status (TPS) information by monitoring uplink transmit power status;
determining whether the BO information is to be transmitted in a current time interval;
determining whether the TPS information is to be transmitted in the current time interval, if the BO information is to be transmitted in the current time interval according to a TPS period;
generating a packet data unit (PDU) comprising the BO information and the TPS information if the TPS information is to be transmitted in the current time; and
transmitting the PDU after coding and modulation.

2. The method of claim 1, further comprising the steps of:
determining whether a TPS information transmission event has occurred if the TPS information is not to be transmitted in the current time interval according to the TPS period; and
generating a PDU comprising the BO information and the TPS information if the TPS information transmission event has occurred and transmitting the PDU.

3. The method of claim 1, wherein the PDU generating step comprises the steps of:
determining whether the TPS information transmission event has occurred if the TPS period has expired and the TPS information is to be transmitted in the current time interval; and
generating a PDU comprising the BO information and the TPS information if the TPS information transmission event has occurred.

4. The method of claim 1, wherein the PDU further comprises uplink packet data.

5. The method of claim 4, wherein the PDU comprises a medium access control PDU (MAC-e PDU) transmitted on an enhanced uplink dedicated channel (E-DCH).

6. An apparatus for transmitting user equipment (UE) status information for uplink data transmission in a mobile communication system, the apparatus comprising:
a buffer for buffering uplink data and generating buffer occupancy (BO) information by monitoring an amount of the uplink data;
a transmit power status (TPS) information manager for generating TPS information by monitoring uplink transmit power status;
a UE status information generator for determining whether the BO information is to be transmitted in a current time interval, determining whether the TPS information is to be transmitted in the current time interval, if the BO information is to be transmitted in the current time interval according to a TPS period, and generating UE status information comprising the BO information and the TPS information if the TPS information is to be transmitted in the current time interval;
a packet data unit (PDU) generator for generating a PDU comprising the UE status information; and
a transmitter for transmitting the PDU after coding and modulation.

7. The apparatus of claim 6, wherein the UE status information generator determines whether a TPS information transmission event has occurred if the TPS information is not to be transmitted in the current time interval according to the TPS period, and generates the UE status information comprising the BO information and the TPS information if the TPS information transmission event has occurred.

8. The apparatus of claim 6, wherein the UE status information generator determines whether the TPS information transmission event has occurred if the TPS period has expired and the TPS information is to be transmitted in the current time interval, and generates the UE status information comprising the BO information and the TPS information if the TPS information transmission event has occurred.

9. The apparatus of claim 6, wherein the PDU further comprises uplink data.

10. The apparatus of claim 9, wherein the PDU comprises a medium access control PDU (MAC-e PDU) transmitted on an enhanced uplink dedicated channel (E-DCH).

11. A method of transmitting user equipment (UE) status information for uplink data transmission in a mobile communication system, the method comprising the steps of:
generating buffer occupancy (BO) information by monitoring an amount of uplink data to be transmitted;
generating transmit power status (TPS) information by monitoring uplink transmit power status;
determining whether the BO information is to be transmitted in a current time interval;
determining whether a TPS information transmission event has occurred, if the BO information is to be transmitted in the current time interval;
generating a packet data unit (PDU) comprising the BO information and the TPS information if the TPS information transmission event has occurred; and
transmitting the PDU after coding and modulation.

12. The method of claim 11, further comprising the steps of:
determining whether the TPS information is to be transmitted in the current time interval according to a TPS period, if the TPS information transmission event has not occurred; and
generating a PDU comprising the BO information and the TPS information if the TPS information is to be transmitted in the current time interval according to the TPS period, and transmitting the PDU.

13. The method of claim 11, wherein the PDU generating step comprises the steps of:
determining whether the TPS information is to be transmitted in the current time interval according to the TPS period, if the TPS information transmission event has occurred; and
generating a PDU comprising the BO information and the TPS information if the TPS information is to be transmitted in the current time interval according to the TPS period.

14. The method of claim 11, wherein the PDU further comprises uplink packet data.

15. The method of claim 14, wherein the PDU comprises a medium access control PDU (MAC-e PDU) transmitted on an enhanced uplink dedicated channel (E-DCH).

16. An apparatus for transmitting user equipment (UE) status information for uplink data transmission in a mobile communication system, the apparatus comprising:
a buffer for buffering uplink data to be transmitted and generating buffer occupancy (BO) information by monitoring an amount of the uplink data;
a transmit power status (TPS) information manager for generating TPS information by monitoring uplink transmit power status;
a UE status information generator for determining whether the BO information is to be transmitted in a current time interval, determining whether a TPS information transmission event has occurred, if the BO information is to be transmitted in the current time interval, and generating UE status information comprising the BO information and the TPS information if the TPS information transmission event has occurred;
a packet data unit (PDU) generator for generating a PDU comprising the UE status information; and
a transmitter for transmitting the PDU after coding and modulation.

17. The apparatus of claim 16, wherein the UE status information generator determines whether the TPS information is to be transmitted in the current time interval according to a TPS period, if the TPS information transmission event has not occurred, and generates the UE status information comprising the BO information and the TPS information if the TPS information is to be transmitted in the current time interval according to the TPS period.

18. The apparatus of claim 16, wherein the UE status information generator determines whether the TPS information is to be transmitted in the current time interval according to the TPS period, if the TPS information transmission event has occurred, and generates the UE status information comprising the BO information and the TPS information if the TPS information is to be transmitted in the current time interval according to the TPS period.

19. The apparatus of claim 16, wherein the PDU further comprises uplink packet data.

20. The apparatus of claim 19, wherein the PDU comprises a medium access control PDU (MAC-e PDU) transmitted on an enhanced uplink dedicated channel (E-DCH).

21. A method of transmitting user equipment (UE) status information for uplink data transmission in a mobile communication system, the method comprising the steps of:
generating buffer occupancy (BO) information by monitoring an amount of uplink data to be transmitted;
generating transmit power status (TPS) information by monitoring uplink transmit power status;
determining whether a current time interval is a BO transmission interval in which the BO information is to be transmitted;
generating a packet data unit (PDU) comprising the BO information and the TPS information, if the current time interval is the BO transmission interval; and
transmitting the PDU after coding and modulation.

22. The method of claim 21, wherein the BO transmission interval is at least one of periodic and event-triggered.

23. The method of claim 21, wherein the PDU further comprises uplink packet data.

24. The method of claim 21, wherein the PDU comprises a medium access control PDU (MAC-e PDU) transmitted on an enhanced uplink dedicated channel (E-DCH).

25. An apparatus for transmitting user equipment (UE) status information for uplink data transmission in a mobile communication system, the apparatus comprising:
a buffer for buffering uplink data to be transmitted and generating buffer occupancy (BO) information by monitoring an amount of the uplink data;
a transmit power status (TPS) information manager for generating TPS information by monitoring uplink transmit power status;
a UE status information generator for determining whether a current time interval is a BO transmission interval in which the BO information is to be transmitted, and generating UE status information comprising the BO information and the TPS information, if the current time interval is the BO transmission interval;
a packet data unit (PDU) generator for generating a PDU comprising the UE status information; and
a transmitter for transmitting the PDU after coding and modulation.

26. The apparatus of claim 25, wherein the BO transmission interval is at least one of periodic and event-triggered.

27. The apparatus of claim 25, wherein the PDU further comprises uplink packet data.

28. The apparatus of claim 27, wherein the PDU comprises a medium access control PDU (MAC-e PDU) transmitted on an enhanced uplink dedicated channel (E-DCH).
